(19) United States
(12) Patent Application Publication
(10) Pub. No.: US 2012/0284623 A1
(43) Pub. Date: Nov. 8, 2012

(54) ONLINE SEARCH, STORAGE, MANIPULATION, AND DELIVERY OF VIDEO CONTENT

(75) Inventor: Robert W. Soderstrom, Los Angeles, CA (US)

(73) Assignee: FLICKBITZ CORPORATION, LOS ANGELES, CA (US)

(21) Appl. No.: 13/466,901

(22) Filed: May 8, 2012

Related U.S. Application Data
(63) Continuation of application No. 12/245,308, filed on Oct. 3, 2008, now abandoned.
(60) Provisional application No. 60/977,817, filed on Oct. 5, 2007.
(60) Provisional application No. 61/043,264, filed on Apr. 8, 2008.

(51) Int. Cl. G06F 3/00

(52) U.S. Cl. 715/719

(57) ABSTRACT

A computer device programmed for managing online video content includes a processing unit that is capable of executing instructions, and a non-volatile computer-readable storage device. The storage device stores a search module programmed to allow a user to search for video content, the video content including video clips from movies. The storage device also stores a storage module programmed to operate as a central hub for management of the user's video content, the storage module allowing the user to add, delete, view, categorize, send, receive, edit, and comment on video clips that are stored on the user's storage module, the storage module being programmed to provide a page on which representations of the video clips are shown and organized, and the storage module being programmed to allow the user to interact with storage modules of other users for purposes of assessing compatibility, dialogue, comments, greetings, gifts, and recommendations.

### RELATED APPLICATIONS

This application claims the benefit of U.S. patent application Ser. No. 60/977,817 filed on Oct. 5, 2007 and entitled “Online Delivery of Greetings Including Video Content,” and U.S. patent application Ser. No. 61/043,264 filed on Apr. 8, 2008 and entitled “Online Manipulation and Delivery of Video Content,” the entireties of which are hereby incorporated by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### BACKGROUND

Internet users manage and exchange online content such as email, music, and pictures on a daily basis. As the speed of Internet connections increase, the type of content that can be exchanged has changed. Users can now download or stream video content from a variety of sources. For example, some online services allow users to download or stream trailers and full-length movies through the Internet. However, these services typically restrict the use of the movies so that the video cannot be manipulated or shared with other users.

Other online systems exist that allow users to send greeting cards to recipients. The greeting cards typically allow the users to select visual and audio aspects of the card. For example, a user can select among different types of cards and can personalize the selected card with text. The visual content associated with such a card is typically static, or can consist of an audio/visual animation.

### SUMMARY

According to one aspect, a computer device programmed for managing online video content includes a processing unit that is capable of executing instructions, and a non-volatile computer-readable storage device. The storage device stores a search module programmed to allow a user to search for video content, the video content including video clips from movies. The storage device also stores a storage module programmed to operate as a central hub for management of the user's video content, the storage module allowing the user to add, delete, view, categorize, send, receive, edit, and comment on video clips that are stored on the user's storage module, the storage module being programmed to provide a page on which representations of the video clips are shown and organized, and the storage module being programmed to allow the user to interact with storage modules of other users for purposes of assessing compatibility, dialogue, comments, greetings, gifts, and recommendations.

According to another aspect, a method for aggregating and building an array of video content based on input from a user includes: storing video content including a plurality of scenes selected by the user; displaying thumbnail images associated with each of the scenes of the video content in an array; allowing the user to arrange a sequence of the thumbnail images in the array; dynamically arranging the sequence of the thumbnail images in the array based on pre-set criteria selected by the user; and sharing the array with other users who can access and play the plurality of scenes by selecting the thumbnail images.

method for selecting, manipulating, and sharing video content in an online environment includes: selecting a scene from a full-length feature movie; manipulating the scene by changing a length of the scene and adding personalized text to the scene; storing the manipulated scene on a page including a plurality of thumbnail images associated with a plurality of scenes stored on the page; and sharing the page so that other users can access and play the plurality of scenes.

According to yet another aspect, a computer-readable storage medium having computer-executable instructions for performing steps including: searching for a scene from a plurality of scenes taking from a plurality of full-length feature movies, the search being performed based on tags associated with each of the scenes; selecting a scene from the plurality of scenes; manipulating the scene by changing a length of the scene and adding personalized text to the scene; interposing the text onto images in the manipulated scene; storing the manipulated scene on a page including a plurality of thumbnail images associated with a plurality of scenes stored on the page; and sharing the page so that other users can access and play the plurality of scenes.

### DESCRIPTION OF THE DRAWINGS

Reference is now made to the accompanying drawings, which are not necessarily drawn to scale.

FIG. 1 is an example system that allows a user to search for, view, manipulate, store, and share video content.

FIG. 2 is the system of FIG. 1 showing the recipient accessing video content shared by the user.

FIG. 3 is an example user interface for the system of FIG. 1.

FIG. 4 is a schematic view of the system of FIG. 1 including a storage module.

FIG. 5 is an example storage module of the user interface of FIG. 3.

FIG. 6 is a logical view of an example server of the system of FIG. 1.

FIG. 7 is an example user interface for editing video of the system of FIG. 1.

FIG. 8 is an example video clip that has been manipulated using the system of FIG. 1.

FIG. 9 is a schematic view of an example video scene.

FIG. 10 is an example user interface for creating an online greeting card using the system of FIG. 1.

FIG. 11 is an example social networking page including a widget associated with the system of FIG. 1.

FIG. 12 is an example flow diagram for a user to search for, select, personalize, and share video content.

FIG. 13 is an example flow diagram for reviewing and tagging a video scene.

FIG. 14 is an example flow diagram for a system to allow a user to create a greeting.

FIG. 15 is a schematic view of an example video content game.

FIG. 16 is an example graphical user interface including a video manipulation and distribution widget.

FIG. 17 is another view of the example widget of FIG. 16.

### DETAILED DESCRIPTION

Example embodiments will now be described more fully hereinafter with reference to the accompanying drawings. These embodiments are provided so that this disclosure will be thorough and complete. Like numbers refer to like elements throughout.

Example systems and methods described herein relate to the online storage, manipulation, and delivery of video content. In example embodiments, users can search for, view, save, modify, and share video clips from various sources, such as full-length movies. Users can combine and exchange video clips in a plurality of manners in both proprietary and online social network environments.

In one embodiment, the example systems described herein include an example storage module with accompanying interface that a user operates as a central hub for management of video content, such as films and film clips, on the Internet, television, or handheld device. The storage module can be dynamic and allows user to add, delete, categorize, send, receive, edit, buy, list, stream, and comment on clips and the films that have been added to the user's own storage module. The storage module also allows user to interact with the storage modules of other users for purposes of compatibility, dialogue, comments, greetings, gifts, recommendations and more. The storage module is also a processing unit designed to record user behavior, tastes and preferences for advertising and other activities. In this manner, the storage module allows video content, such as film clips, to become not just a static piece of entertainment but an actionable item to be used to convey feelings, communicate greetings, edit and personalize, purchase and give gifts, express tastes, or meet new people.

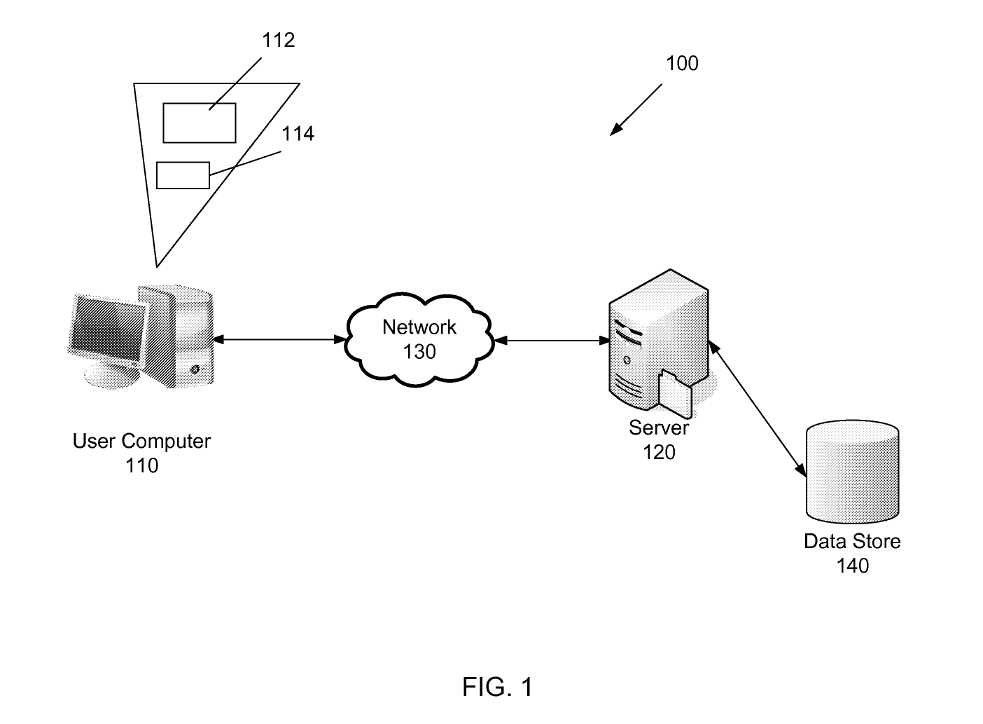

Referring now to FIG. 1, an example system 100 is shown that is configured to allow a user to search for, store, manipulate, and share video content such as video clips. In order to do so, the user uses a computer device 110 to communicate with a server 120 through a network 130. In the embodiment shown, the video content is stored in a data store 140.

In example embodiments, the system 100 allows the user to select video content, such as movie, television, or sports scenes, to view, store, manipulate, and/or share with others. For example, in one embodiment, the user can select one or more video clips, personalize the clips, and share the clips as part of an online greeting card or message, or as part of a shared media space such as a social networking site. As described further below, the user can search for available scenes by contacting the server 120 and browsing various categories, such as “first kiss,” “retribution,” or “victory.”

The user can view the desired scene and choose when the scene should stop and start, and then place a greeting at the beginning, middle or end of the scene. The user can also add text to certain parts of the scene and add commentary, as described below. The video clips can also be manipulated to include other text, a photo, or a talking avatar or animation.

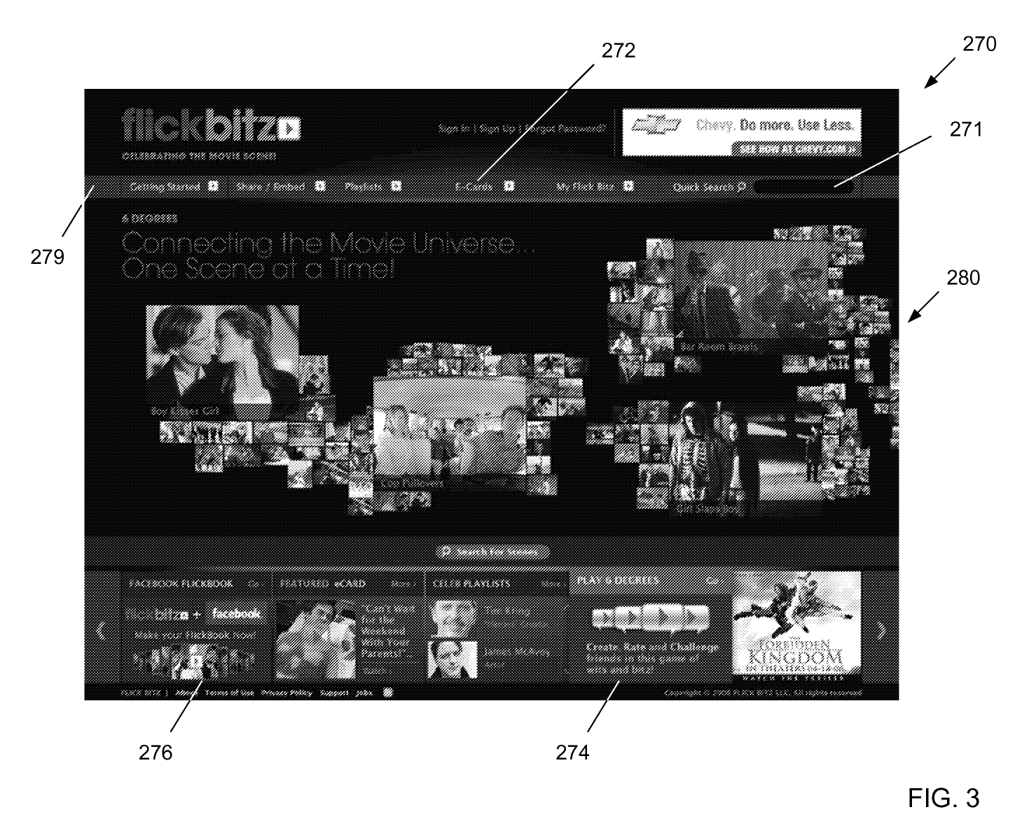

When the user is finished with selection and manipulation of the video clips, the server 120 stores the video clips, and the user can share the video clips in various manners. For example, the user can store the video clips on the user's storage module, as shown in FIGS. 3-5. In other embodiments, the user can post one or more of the clips to the user's online social network page to share with other friends.

In yet other examples, the user can also send the video clips as part of an online greeting to a recipient. In some embodiments, notification of the greeting is delivered to the recipient in the form of a message such as an email message or a SMS message. The greeting includes a link to the server 120 that, when accessed by the recipient, delivers the greeting card including the video content to the recipient.

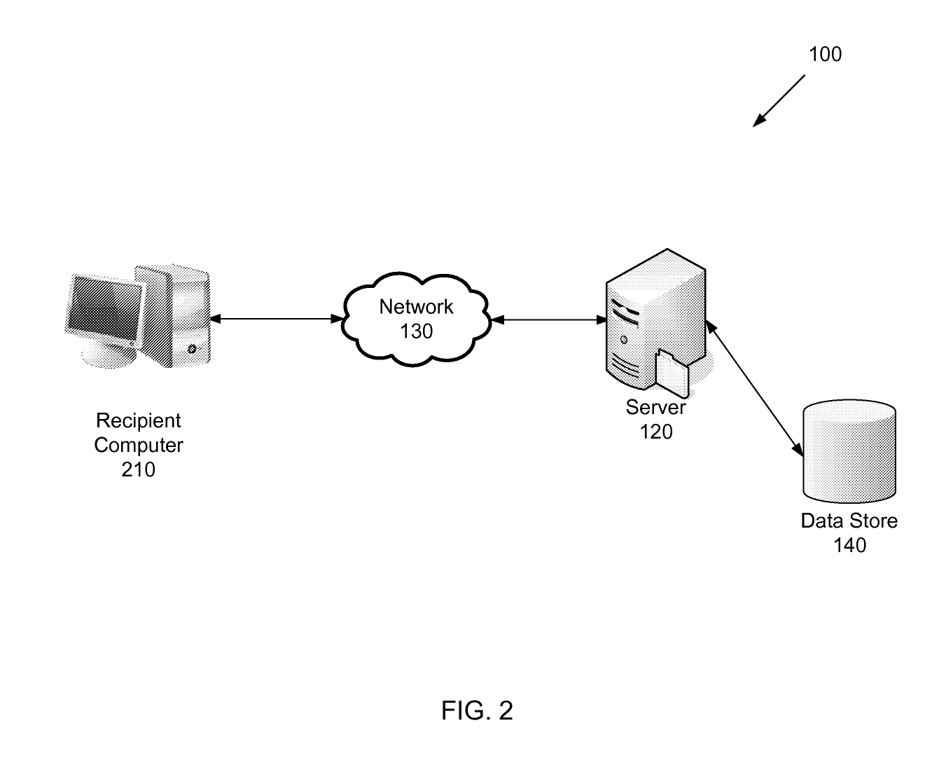

Referring now to FIG. 2, a second user can access and view the stored video clips in various manners. For example, if the user chooses to share the user's storage module or post the video clips on the user's social network page, the second user can access and view the clips by visiting the user's storage module or social network page. Also, if the user sends a greeting, the recipient can access the link in the message to receive the greeting. Specifically, the recipient uses a computer 210 to access the server 120 through the link included in the message. The greeting is then delivered to the recipient.

In example embodiments, the video content that is available on the system 100 can include one or more of movies, television shows, music videos, recorded sporting events, or the like. In one embodiment, the video content is non-original content, meaning that the video content was originally developed for a purpose other than for use on the system 100. For example, the video content can be movies that are created by movie studios. In alternative embodiments, the video content can be original content, meaning that the system and/or user creates the video content specifically for use in the sending of greetings.

In some embodiments, the video content is stored on the data store 140 while the user browses and chooses the video content, customizes the video content, stores the content, and/or shares the video content. In addition, the video content continues to reside on the data store 140 when the recipient views the greeting. In this manner, owners of non-original content, such as a movie studio, can control access to the video content by owning the data store 140. The server 120 only needs to provide access to the video content on the data store 140 during creation and delivery of the greeting. The video content itself (and the security thereof) can be controlled by the video content owner through, for example, encryption of the video content, as described below. In alternative embodiments, the server 120, alone or in combination with one or more data stores, can store and deliver the video content.

In examples described herein, the computer devices 110, 210 and the server 120 are each computer systems. For example, computer 110 includes a processing unit or processor 112 and computer readable media 114. Computer readable media can include memory such as volatile (such as RAM), non-volatile (such as ROM, flash memory, etc.) or some combination thereof. Additionally, computers can also include mass storage (removable and/or non-removable) such as a magnetic or optical disks or tape. An operating system, such as Linux or Windows, and one or more application programs can be stored on the mass storage device. The computers can include input devices (such as a keyboard and mouse) and output devices (such as a monitor and printer). The computers can also include network connections to other devices, computers, networks, servers, etc.

In example embodiments, the computers can communicate with one another over the network 130. In example embodiments, the network 130 is a local area network (LAN), a wide area network (WAN), the Internet, or a combination thereof. Communications between the computers and the network 130 can be implemented using wired and/or wireless technologies.

In example embodiments, the server 120 includes one or more web servers that host one or more web sites that are accessible from the network 130. The server 120 accesses one or more data stores such as, for example, the data store 140. One example of such a data store is a database having SQL Server software offered by Microsoft Corporation of Redmond, Washington. Other configurations are possible.

In the embodiments disclosed herein, the user and recipient use the computers 110, 210 to access one or more web sites hosted by the server 120. For example, each of the computers 110, 210 includes a web browser to access the server 120 over known protocols such as hypertext markup language (“HTML”) and/or extensible markup language (“XML”). Other media formats, such as Flash media, can also be used. One example of a browser is the Internet Explorer browser offered by Microsoft Corporation. Other types of browsers and configurations are possible.

Referring now to FIG. 3, an example user interface 270 is shown for one embodiment of a system that allows for online search, storage, manipulation, and sharing of video content. The user interface also allows for streaming advertising and purchasing of video content, such as movies. The user interface 270 is typically displayed to a user in an Internet browser.

The user interface 270 includes functionality similar to that described above. For example, the user interface 270 includes a menu bar 279 with a plurality of menu items that allow users to search for, view, manipulate, and share video content. For example, the menu bar 279 includes a search field 271 that the user can input keywords into to search for desired video content, as described below. The menu bar 279 also includes a menu item 272 that the user selects to create online greeting cards including video content. In example embodiments, when the user selects items from the menu bar 279, the selected items can be loaded into the user interface 270. In addition, the user interface 270 includes, among other functionality, a game module 274 and a social networking module 276 that are described further below.

The user interface 270 also includes a storage module 280 onto which a plurality of video content can be represented. As described above, the storage module 280 can act as a central hub for management of video content, such as films and film clips, on the Internet, television, or handheld device.

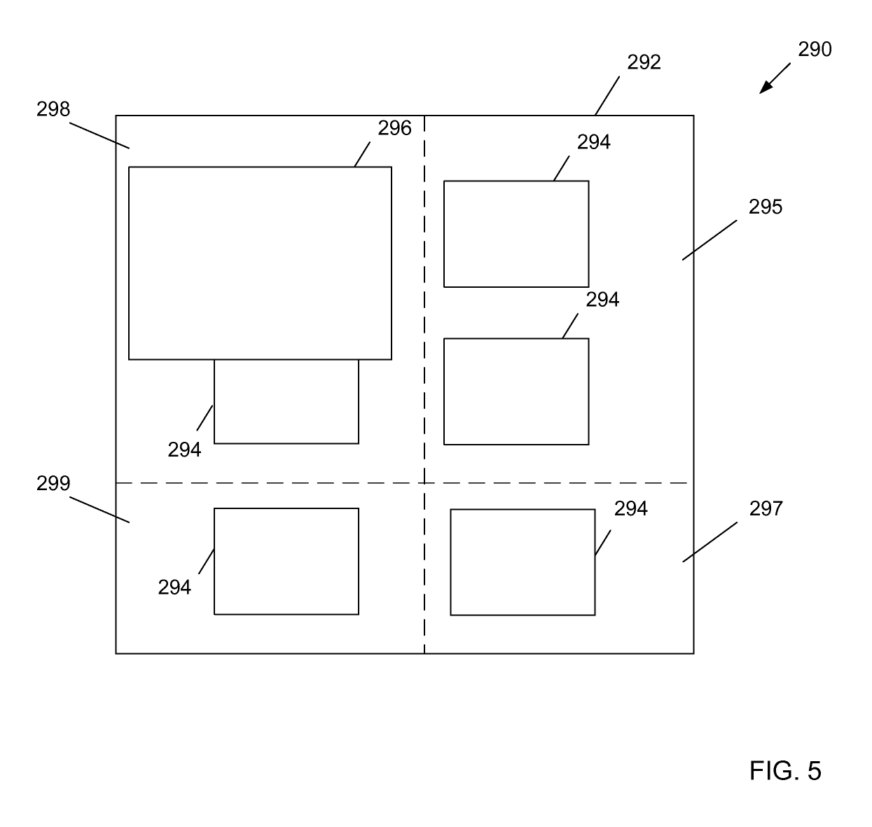

In example embodiments, the storage module 280 is a collage comprised of thumbnail images from all clips/scenes that a user has viewed. The user's storage module 280, for example, may contain hundreds of thumbnail images. Visually and digitally, the storage module 280 can look like a giant wall (see FIG. 5) that is many images (thumbnails) tall and wide. Using a cursor, the user can cruise down the wall and at any point click on an image (a thumbnail) and watch that video clip. The user can choose that the user's storage module 280 be private or public for all eyes, or accessible only by a few select friends.

The storage module 280 is visual and interactive. The user can organize the user's storage module 280 to show off the number (and quality) of films/clips they've seen. The storage module 280 can also be used as an organizing and tracking tool. As soon as a user registers with the system 100, the system 100 begins tracking the user's path and clips viewed. Every clip viewed is automatically sent by the system 100 to the user's storage module 280. A visit that yields 10 clips viewed, therefore, will show 10 clips when the user views the user's storage module 280. Those clips will be there when the user re-visits the site the following week, when they view 4 more clips, meaning that their storage module 280 now contains 14 clips.

As described further below, a user may be able to rearrange their storage module 280 in many ways. Further, other users may post a clip on the user's storage module 280 under a “Recommended by Friends” section. The user can also recommend clips or other content to other users by send recommendations to other users in the user's address book (or friend on Facebook) by posting a clip on the user's “Recommend” section of the user's storage module 280. That action will pop-up in their Facebook newsfeed.

The user doesn't necessarily need to watch a clip for it to appear on the user's storage module 280. The user can simply check the movies that the user watched in their lives and the system will send the clips associated with the movies to the storage module 280. In this manner, the user can show others what the user has watched. The user's storage module 280 can become the user's own “channel” in the sense that other users can view the user's channel and rate the user's films, communicate with him, get ideas for their own channels, etc.

As described further below, the storage module 280 can also be mined for user behavior and preferences and, as a result, be used by advertisers on the system 100.

In example embodiments, when a user selects a video clip using one or more of the methods described below, the video clip can be automatically stored on the storage module 280 so that the user can later access, view, and/or share the video clip. For example, video clips can be added to the storage module 280 when the user views each clip and/or when the user selects a clip and indicates that it should be saved by the storage module 280 (e.g., by right-clicking on the clip and selecting a “Save” item from a pop-up menu). Also, clips can be added to the storage module 280 based on information provided by the user (e.g., the user can indicate which movies the user has seen, and the scenes from those movies can be auto-populated into the storage module 280), as well as based on recommendations from other users. The user can also remove video content from the user's storage module 280 if the user does not like the content or otherwise wants to remove the content from the user's storage module 280.

In addition, the user can select any of the video content on the storage module 280 and automatically forward the information regarding the video content to another system, such as an online music store or online video rental store. For example, if the user likes a music track that is performed in a video clip, the user can automatically forward metadata associated with the music track to the user's iTunes or Rhapsody accounts so that the user can easily download the desired music track. In addition, the user can forward the information to a service that allows ring tones to be downloaded to the user's cellular device. In another example, the user can automatically forward metadata associated with the video content to the user's online video account, such as the user's NetFlix, Blockbuster, and/or CinemaNow (www.cinemanow.com) accounts, so that entire movie associated with the video clip can be added to the user's rental queue and/or downloaded by the user for viewing. In other examples, the online music and/or video store can also be configured to drive users to the system 100.

In other embodiments, the system 100 can provide downloads and/or streaming of full movies associated with video content on the system 100. For example, if the user selects video content on the user's storage module, the system 100 can be programmed to allow the user to stream the entire movie associated with the video content. In other examples, the system 100 can provide a “skinned” interface that overlays other content providers, such as iTunes or CinemaNow, that allow user's to locate audio and/or video content.

In example embodiments, the thumbnail image associated with particular video content can be modified to provide information to the user indicating that the system 100 includes additional content for with the video clip associated with the thumbnail image. For example, if the system 100 includes a full version of the movie from which a video clip is taken, the thumbnail image for the video clip can be modified to include a green “+” system that signals to the user that the full version of the movies is available to the user on the system 100 for purchase, as described herein. Other indicators, such as an indicator that a video clip is associated with a channel (described below) on the system 100, can also be provided.

Content from any of these sites can be purchased and stored on the user's storage module 280. In addition, the user can share the content with others. For example, if the user purchases a movie using the system 100, the user can thereupon create a greeting card, as described below, to send the movie to a recipient. The greeting card lets the recipient know that the user has purchased a movie for the recipient as a gift to allow the recipient to download and/or stream to view the video.

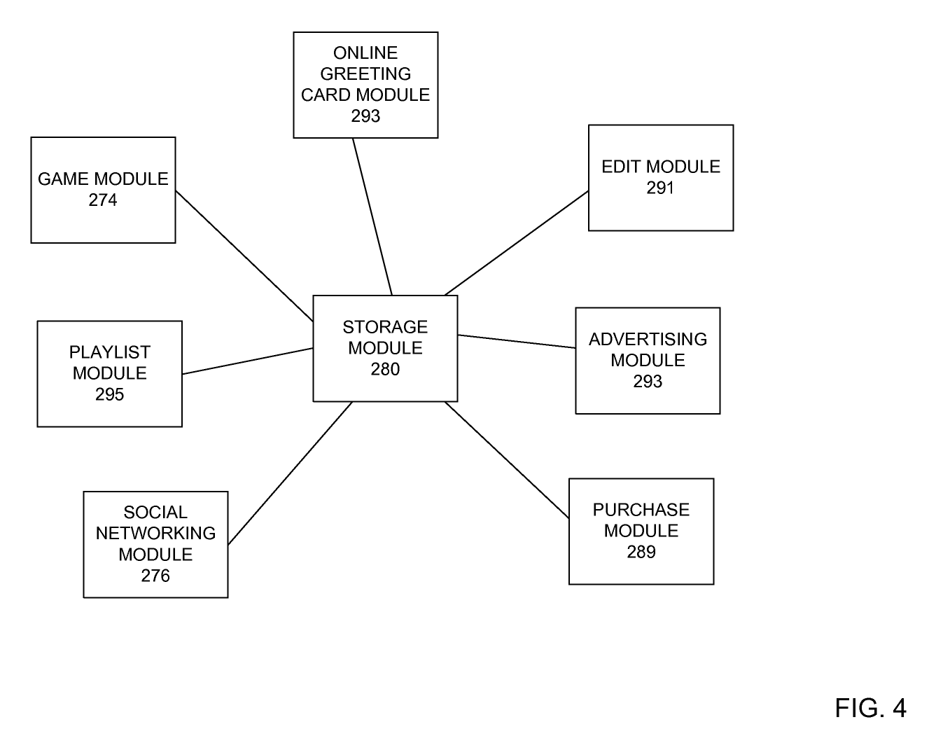

Referring now to FIG. 4, the storage module 280 is shown schematically in relation to other modules of the system 100. The storage module 280 is the central module of the system that links all of the other modules together. For example, the storage module 280 links other modules of the system 100 such as the game module 274, a playlist module 295 (which allows users to generate playlists of video clips), the social networking module 276, a purchase module 289 (which allows users to purchase and/or stream video content such as movies), an advertising module 293, an edit module 291, and an online greeting card module 293.

The storage module 280 unifies the other modules of the system 100 by allows for a centralized place where all of the video content for the user is stored and organized. The storage module 280 can act as a recording device that captures all of the video content that is explored by the user. As described herein, the user can easily add, organize, and delete the video content on the user's storage module 280. In addition, the user's storage module 280 can be compared to other users' storage modules to identify similarities and difference, as described further below. In such a context, the user can make the user's storage module 280 public so that other users can review the video content on the user's storage module 280.

The unifying aspects of the storage module 280 allow the user to access most or all of the functionality associated with the system 100 directly from the storage module 280. Further, the user's activities while using other modules of the system 100 are captured by the storage module 280, such as the recording of the video content viewed by the user. In this manner, the user can have a consistent experience when using the system 100.

In the example shown, the storage module 280 is one or more pages including a plurality of clips represented by thumbnail images that show a static or animated representation of each clip. The clips can be organized and shown in a variety of different manners. For example, some of the clips shown on the storage module 280 are larger than others. This can be used to signify the importance of particular clips (e.g., the clips that have been watched most by the user or others and/or the clips last viewed). In other examples, the thumbnail images for the clips can increase in size when the user hovers over the clip. The user can move the thumbnail images around on the storage module 280 as desired to create a collage or organize the clips. Further, a desired icon can be selected and the video clip can be played while pinned to the storage module 280, or can be played separately in a viewer.

For example, referring now to FIG. 5, a schematic view of another example storage module 290. The storage module 290 includes a plurality of thumbnail images 294 that represent video content. In example embodiments, the storage module 290 is presented as an array of thumbnails in rows and columns. The thumbnail images can be dragged and dropped to rearrange the content on the storage module 290, and the user can select various pre-set criteria that cause the system to automatically or dynamically rearrange the thumbnails based on the criteria, as described further herein. In addition, the storage module 290 includes a thumbnail 296 that is larger than thumbnails 294 to give prominence to the video content represented by the thumbnail 296 for one or more of the reasons described above. In addition, the storage module 290 is divided into sections 295, 297, 298, 299, and the thumbnail images 294, 296 are arranged into the sections 295, 297, 298, 299 based on specific parameters, as described above. For example, each of the sections 295, 297, 298, 299 can represent a different actor, and the thumbnail images 294, 296 for the video clips can be arranged into the sections 295, 297, 298, 299 based on the actor in the video clip. For example, all of the thumbnail images 294 representing the video clips in the section 295 can include John Travolta.

Other organization techniques include by favorites, by movies seen, by genre, etc. In addition, the video content can also be organized by “movies not seen.” For example, the system 100 can auto-arrange the video content to indicate that the user has seen all of the films by Woody Allen, but none by Alfred Hitchcock. In such a configuration, the area of the storage module devoted to Alfred Hitchcock would be empty to indicate this.

In addition to sharing the content on the storage module 290, the user can also recommend video content to friends. For example, the user can select video content on the user's storage module or another individual's storage module that has been shared, and then forward that video content to other users to recommend that other users view the video content. In yet other examples, the storage module 290 can be programmed to allow one or more live video and/or audio feeds. For example, a web cam can be used to add personal videos of the user that can be added to the storage module 290. These can be organized to create a collage or other desired effect.

In one example, the storage module 290 is organized so that the storage module 290 includes an Inbox, Sent Box, and other user-created folders or workspaces. The Inbox can hold and organize video content received from others, and the Sent Box can hold video content that has been sent to others. The user can also create folders, such as “Favorites,” that can be used to organize video content based on different parameters, such as actors (e.g., Robert DeNiro, etc.) or genre (e.g., Science Fiction).

In yet other examples, the user can arrange the video clips on the storage module to create playlists of clips that are shown in succession. In other examples, the system 100 can interface with another content system, such as PANDORA® at www.pandora.com. This system assists the user in developing playlists for music. The system 100 can interface with such a music playlist system and automatically recommend and/or show video clips that are associated with the music on the user's playlist. For example, if the user develops a playlist with a number of songs by a particular music artist, the system 100 can recommend video clips that include music performed by that artist. In yet other examples, the system 100 can be programmed to automatically develop video clip playlists based on the user's preferences. In some embodiments, the system 100 is programmed to automatically save the video clips that are watched by the user in the user's playlist to the user's storage module. Other configurations are possible.

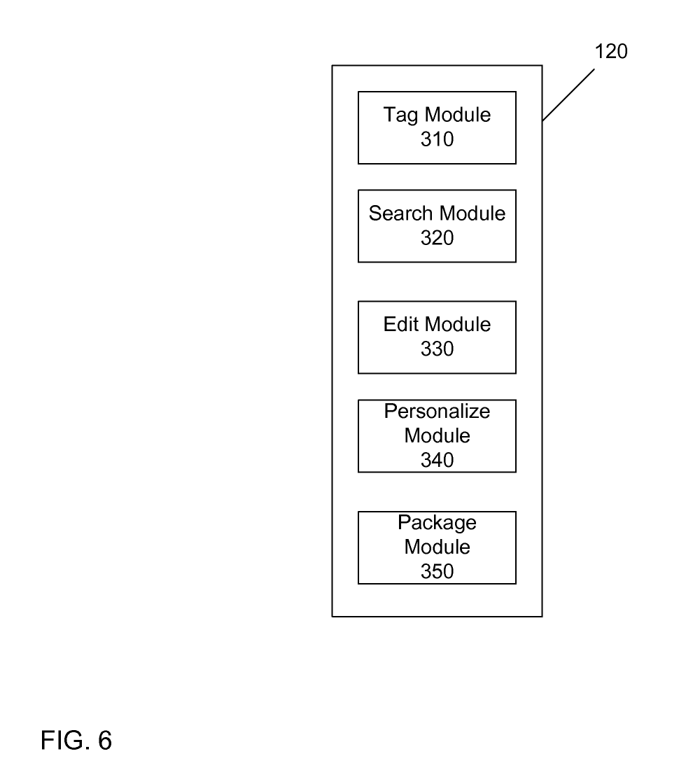

Referring now to FIG. 6, in some embodiments, the server 120 includes one or more application programs having various modules that allow the user to search, edit, personalize, store, and share video content. In the example shown, the server 120 includes a tag module 310, a search module 320, an edit module 330, a personalize module 340, and a package module 350.

The tag module 310 is configured to allow video content to be broken down into scenes, and each of the scenes to be tagged for later retrieval by the user. For example, the tag module 310 can be used to create an index for movies by tagging scenes within that movie with certain tags (e.g., boy meets girl, boy kisses girl, girl dumps boy, types of physical motion patterns, etc.). Users are then able to search for desired type of scene that best expresses the user's sentiments. The scene can then be included as part of the greeting.

In one embodiment, the tag module 310 is automated such that the server 120 is programmed to automatically parse video content, break the content into scenes, and tag the scenes with the relevant tags. For example, the tag module 310 can be programmed to crawl a movie and identify the placement of certain words in the film, such as “I love you,” or “Bond, James Bond.” In one example, the tag module 310 is programmed to conduct voice recognition to identify relevant keywords in a scene to tag the scene. In other embodiments, the tag module 310 is programmed to crawl a transcript or screen play associated with each scene to identify the keywords. In some embodiments, the keywords are compared to a list of words in an index to determine which tag or tags to associate with a given scene.

In another embodiment, the tag module 310 is a manual module that allows one or more individuals to review video content, identify scenes, and tag the scenes appropriately. The tag module 310 can be programmed to receive tags from multiple individuals and to resolve conflicts in the manner in which a scene is tagged. For example, if a scene is tagged using a first tag by one individual and is tagged using a second tag by a second individual, the tag module 310 can be programmed to associate both tags with the scene, and/or create an alert indicating that the scene has been tagged differently.

In yet another example, the tag module 310 can be used in both automated and manual fashions. For example, a bot can be programmed to initially tag scenes, and an individual can then review and modify the tags, as necessary. Other configurations are possible.

The tags can be organized in a particular hierarchy such that the user can browse categories associated with the tags to identify desired content, as described below.

In some embodiments, the content that is reviewed and tagged can be selected based on certain criteria. For example, the content can be selected so as to be appealing to a particular demographic. For example, music videos from the 80's can be reviewed and tagged to appeal to 30 and 40 year-old individuals. In other examples, the content can be chosen based on popularity. For example, content can be selected based on the top 50 most-watched movies for a particular genre, or even selected based on the most-watched scenes in particular movies. Other selection schemes can also be used.

Each selected scene can include one or more tags. Not every scene from a particular video needs to be included. For example, as part of the review process, the tag module 310 can be used to select only those scenes from a video that are desirable to include for users. In other examples, video content (e.g., a music video) may include only a single scene.

The tag module 310 therefore allows video content, such as a movie, to be broken into a series of scenes. In this manner, video content is atomized into various scenes that include tags that can be indexed and searched for a scene that captures the event, emotion, or theme that the user is attempting to convey in an online greeting, as described further below.

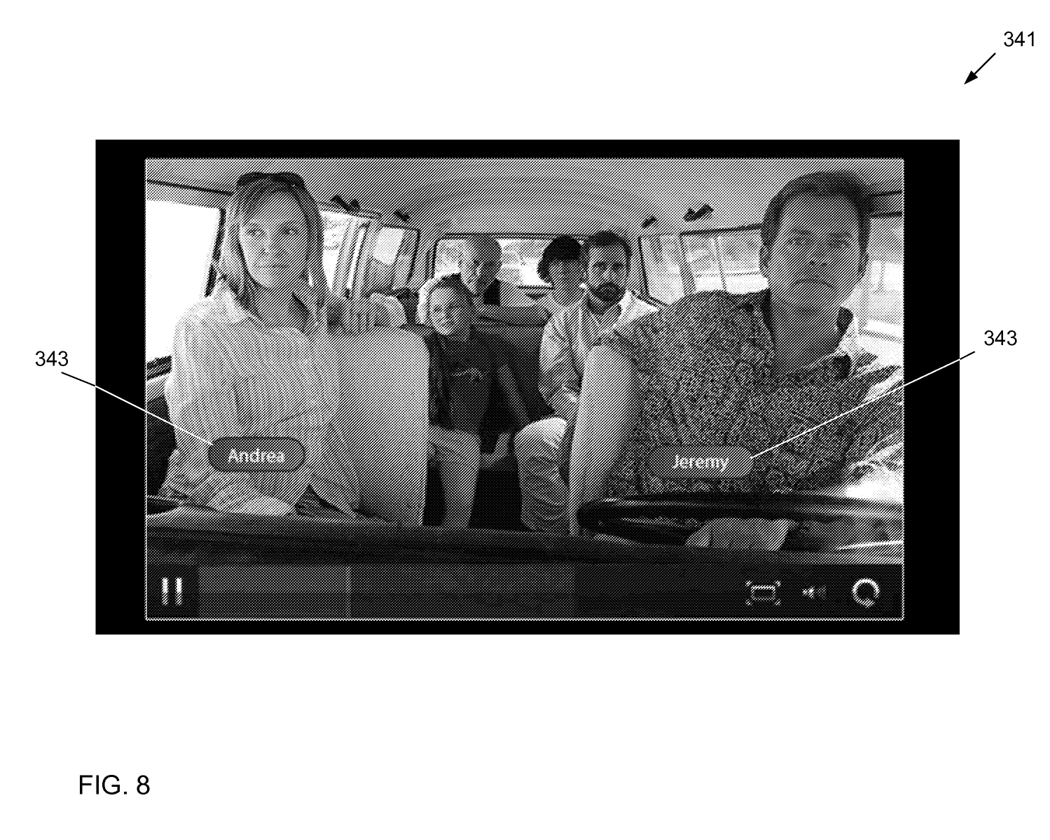

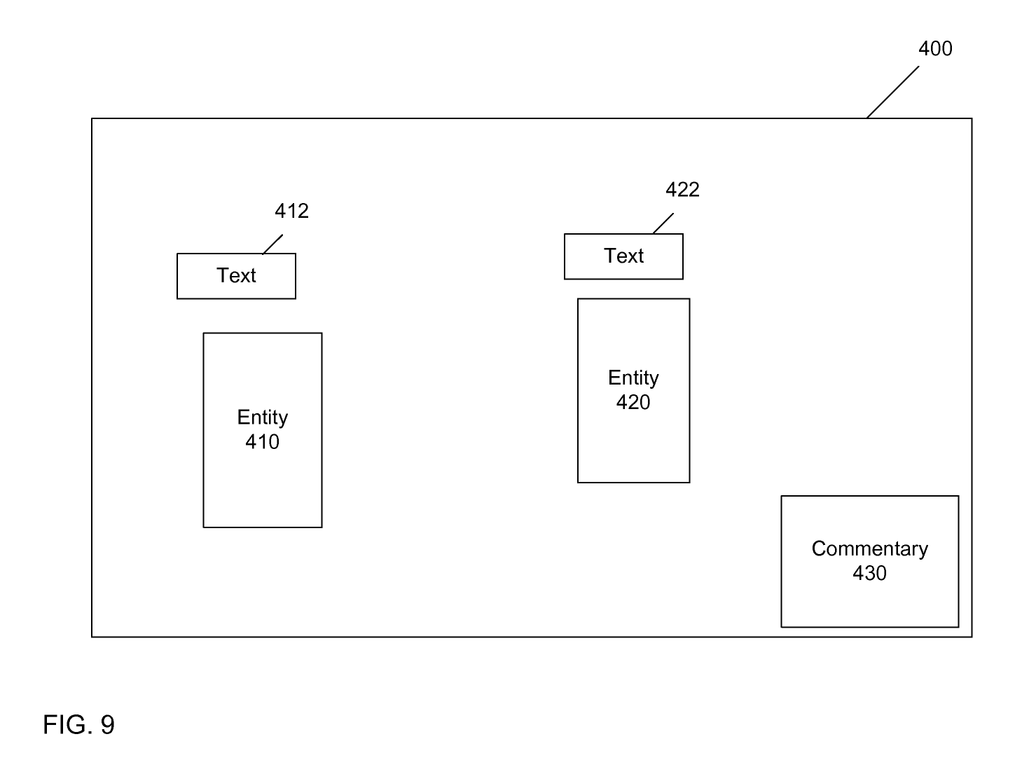

In one example, the information about each scene can be defined according to a given set of criteria. For example, an XML-based system can be used that defines the relevant fields associated with each scene. Such an XML-based system can include the following fields: content type (e.g., movie, television show); title; start time (e.g., time at which scene starts in movie); stop time (e.g., time at which scene stops in movie); tags; entities (as described below with respect to FIGS. 8 and 9); synopsis (e.g., narrative describing movie or scene itself); creation date; release date; genre; actor/actress names (e.g., actor names, actress names, athlete name, etc.); character names; team names; and geography (actual and/or virtual, possibly including Global Positioning System (GPS) data). Other fields can also be used.

The search module 320 allows users to search for desired video content available on the system 100. For example, the user can input one or more keywords into the search field 271 of the menu bar 279 on the user interface 270 shown in FIG. 3 to identify desired video content. The user can enter a Boolean search to identify desired scenes by video name, scene name, scene synopsis, scene tags, and/or one or more of the fields identified above. In other embodiments, the user can identify desired scenes by browsing and/or searching using the tags or a classification index, such as the search index 969 shown in FIG. 960.

In other examples, the user can browse categories and sub-categories of scenes (which have been indexed by scene tag). Some of the scene categories can include: Romance, Inspiration, Comedy, Action, Friendship, Wedding, Science Fiction, Holiday, Sports, Politics, and Adult. Each of these categories can have further sub-categories associated therewith. For example, the Romance category can have sub-categories such as boy meets girl, boy kisses girl, girl dumps boy, etc. As noted above, the categories and sub-categories can be arranged in a hierarchy.

In addition, the system 100 can be organized into channels, with each channel being organized based on a particular theme. For example, the search module 320 can include a plurality of channels associated with particular actors or genres. The user can user search module 320 to identify a channel that interests the user, such as a channel devoted to Robert DeNiro. Video content featuring Robert DeNiro can thereupon be accessed through the page associated with this channel.

In yet other examples, the search module 320 allows the user to identify bundles of clips that are created based on a common theme. For example, bundles are created by the system that include tops scenes from a variety of movies for a particular actor. The bundles can be organized chronologically or in other manners, such as by theme, dress, emotion, etc. This allows the user to search for and view bundles of clips from favorite actors.

In yet other embodiments, the search module 320 can be programmed to further assist the user in identifying relevant scenes. For example, the search module 320 can include a wizard that queries the user to assist the user in finding relevant scenes, and editing and personalizing the video content. For example, the search module 320 can be programmed to present a series of questions to the user (e.g., “What is the occasion for which you are looking for a greeting?”, “Are you looking for a funny greeting?”, and “How old is the recipient?”) to assist the user in finding relevant scenes. In other examples, the user can also review scenes that are popular with other users to help the user to find desired scenes. For example, the search module 320 can track the number of times a particular scene is selected by users, and can also allow users to rate scenes. Other configurations are possible.

Once the user identifies a scene, the search module 320 allows the user to preview the scene to allow the user to verify that the desired scene has been selected. After the user has identified the desired scene, the user can edit and personalize the scene before storing and/or sharing the scene, as described below.

The edit module 330 allows the user to edit the run time of the selected scene. In some embodiments, the edit module 330 is programmed to allow the user to select the entire scene, or only a segment of the scene for the recipient. For example, if the entire scene is three minutes long, the user may wish to only send a segment of the scene to the recipient. In such a case, the user can use the edit module 330 to define the desired segment of the greeting to send to the recipient, e.g., 30 seconds including the most relevant portion of the scene. In other examples, the user can watch an entire movie and select segments of the movie to edit and share with others.

The edit module 330 therefore allows the user to define the start and stop times for the portion of the scene selected by the user. In some embodiments, the edit module 330 is also programmed to allow the user to select and trim multiple segments from one or more scenes and to combine the segments into a single greeting that is sent to the recipient. The user can also pause and fast-forward through certain segments to further customize the scene. For example, the user can speed up, slow down, and/or stutter certain portions of a scene to create a desired effect.

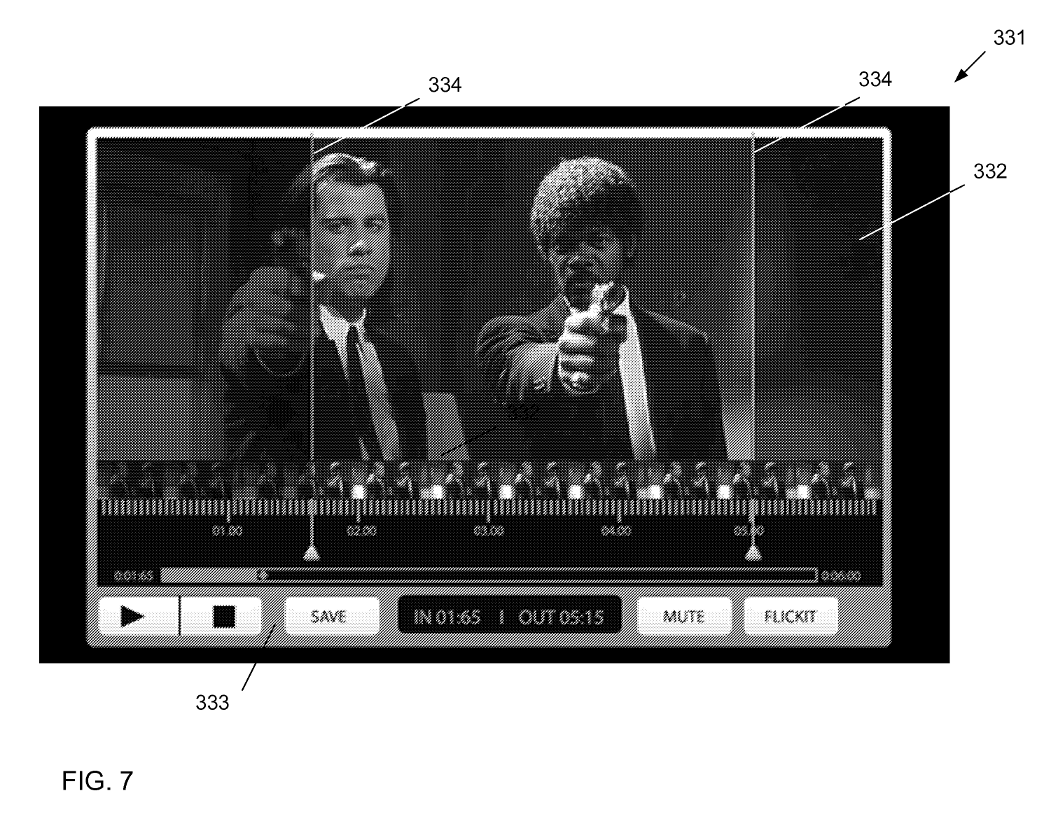

For example, referring to FIG. 7, an example user interface 331 for editing video content is shown. The interface 331 includes a video play 332 that allow the video to be played for the user. A control panel 333 allows the user to start, stop, mute, and save the video clip. When saved, the video content can be automatically stored and displayed on the user's storage module 280, as shown in FIG. 3.

The control panel 333 also provides an indication of the length of the edited video clip based on control bars 334 that can be moved by the user. The control panel 333 also allows the user to share the content with others (e.g., by selecting the “FlickIt” button). The bars 334 can be moved horizontally individually in the right or left directions to increase or decrease the length of the edited clip, and the clip length is reflected in the control panel 333.

In example embodiments, the user can create a montage of two or more scenes into a single scene that is sent to the recipient. For instance, the user can select, edit, and combine multiple scenes having a particular attribute (e.g., having a specific theme, or having a specific actor/actress) together into a single montage scene. The user can modify the manners in which each of the segments of the montage is played so as to meld multiple scenes into a desired effect.

In some examples, a set of pre-created scenes can be provided to the user. For example, the user can select among various pre-packaged scenes categorized by various themes. The pre-created scenes can include various effects and can, for example, include a montage scene to create a desired effect.

Once the editing is complete, the user can then personalize other aspects of the video content, as described below.

Referring back to FIG. 6, the personalize module 340 allows the user to customize other aspects of the video clip. For example, the user can use the personalize module 340 to add text to be shown to the recipient before or after the scene is played if the video clip is to be used in conjunction with an online greeting card. The font size and text color are configurable. For example, the user can add the text “Happy Birthday Dad!” to the beginning or end of a scene.

The user can also add commentary as the scene is played. For example, the user can add text that is shown to the recipient at specific intervals during the scene, as well as select where the commentary is displayed on the scene. See, e.g., a commentary box 430 shown in FIG. 9. In some embodiments, the personalize module 340 allows the user to also select an avatar that can be used to deliver the commentary, similar to a director's commentary on a scene. The avatar can be animated and programmed to appear to be speaking the words of the commentary. Alternatively, the avatar can be static and simply be associated with the commentary as it is displayed to the recipient. The commentary can be visual and/or audible. For example, text-to-speech technology can be used to recite the commentary as the scene is played for the recipient.

The user can also use the personalize module 340 to interpose text into the scene itself. For example, the personalize module 340 can allow the user to add text to entities within the scene, such as characters or other objects. For example, the personalize module 340 allows the user to place text, such as a name tag, that is positioned above/below or on a character in the scene. This text can be configured such that the text is persistent throughout the whole scene, is only shown at and/or for a certain period of time, or is shown periodically throughout the scene.

For example, referring now to FIG. 8, a user interface 341 shows a video clip that has been personalized by interposing text 343 into the scene itself. The text 343 is used to give personal names to the actors depicted in the scene. The text 343 can be static or change as the scene changes, as described below.

For example, referring now to FIG. 9, in some embodiments, the text added to the scene can be configured to follow the entity to which the text is associated as the entity moves throughout a scene 400. The scene 400 includes two entities 410, 420. In examples, the entities 410, 420 can be characters or other objects shown in the scene 400. The user adds text 412 associated with the entity 410, and text 422 associated with the entity 420. The personalize module 340 is programmed to have the text 412 follow the entity 410 as the entity 410 moves throughout the scene 400, and to have the text 422 follow the entity 420 as the entity 420 moves throughout the scene 400.

In one example, each entity 410, 420 in the scene 400 is assigned a target value. For example, the entity 410 can be assigned a target value A, and the entity 420 can be assigned a target value B. The position of each entity 410, 420 is tracked throughout the scene. For example, the tag module 310 can be programmed to automatically identify entities in a scene, assign target values the entities, and to track the entities as the entities move throughout the scene. In other embodiments, the tag module 310 allows individuals to manually identify, assign target values, and track entities in the scene.

Once the user selects the scene, the personalize module 340 presents the user with a list of the target values associated with the entities in the scene. For example, the user is presented with the target value A associated with the entity 410, and the target value B associated with the entity 420. The user can choose to associate text with one or both of the entities 410, 420, as well as to choose where the text is placed (e.g., above, below, over/on, or alongside the entity), how long the text is shown (e.g., at the beginning of the scene, persistently throughout the scene, at certain intervals throughout the scene, or periodically throughout the scene), and the format of the text (e.g., font, size, and color).

In some examples, the user can choose to have the text boxes 412, 422 to appear as labels for the entities 410, 420, or have the text boxes 412, 422 appear as dialog or thought-bubbles for the entities 410, 420, or as caption text positioned below the scene. When the scene is played, the text can thereby follow the entities throughout the scene.

For example, if a user selects a romantic scene to send to his wife, the user can add a text label to the male in the scene identifying himself, as well as add a label to the female identifying her as the wife. These labels can follow the male and female through the scene. In this manner, the scene can be further personalized for the recipient.

Referring again to FIG. 6, the package module 350 is programmed to package the video content for sharing. For example, the personalized video content can be posted to the user's storage module 280 shown in FIG. 3. The video content can be incorporated as part of the user's online social networking site, as described.

In another embodiment, the user can choose from a plurality of graphic interfaces to send to the recipient to customize the recipient's experience when opening the greeting. The user can select among different colors, envelopes, and logos (e.g., for schools, sports teams, etc.) to be associated with the greeting.

The user can also customize the “venue” shown surrounding the scene that is delivered to the recipient. For example, the user can select between venues such as a junk yard, school room, park, drive-in theater, stadium, or on the side of Grand Central Station. The user can configure other attributes such as projector sounds, cheering, etc. The user can also choose how the scene is shown as it is delivered to the recipient. For example, the user can select one or more still or moving images that are displayed to the user before or after the scene is played, or choose to display a frozen image at the beginning, end, or other part of the scene. The user can also display a text message to the recipient.

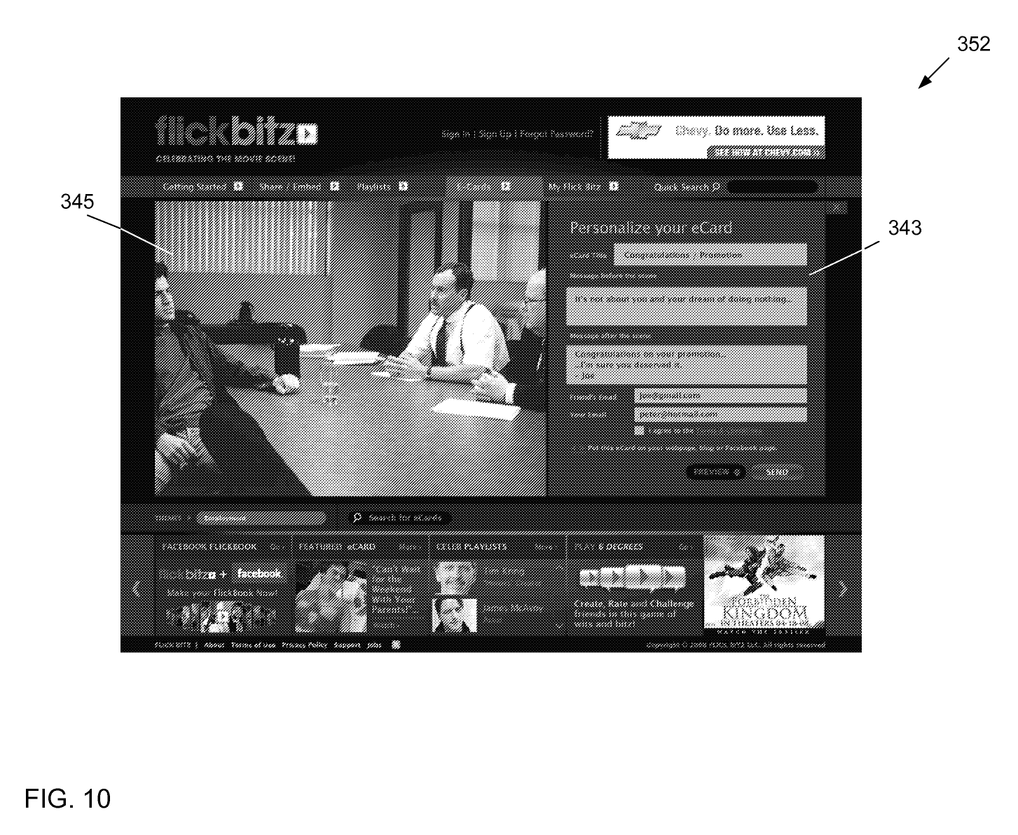

For example, referring now to FIG. 10, an example interface 352 is shown for creating an online greeting card (“eCard”). The interface 352 includes a personalization panel 343 that allows the user to add personal information like a title and message. The message can be configured to be shown at various times, such as before and after the video content. The panel 343 also allows the user to add email addresses for the recipients. A panel 345 allows the user to view the video content. The user can select a preview button from the panel 343 to preview the online greeting card, and can select a send button to send it to the desired recipients, as described herein.

In some embodiments, advertisements are displayed to the recipient before, during, and/or after the recipient views the greeting. In one example, the user and/or recipient can choose to pay a premium in order to reduce or eliminate advertisements that are played for the recipient. In examples, the advertisements can be static, such as banners positioned above or below the greeting. In other examples, the advertisements can be positioned to overlay the video content itself, such as by being semi-transparent, so that the recipient can see the underlying video content while the advertisement is displayed.

In example embodiments, advertisements can be delivered based on a profile for the user that is created by analyzing the user's viewing habits. For example, the system 100 can automatically analyze the content of the user's storage module and serve relevant advertisements to the user. For example, if the user has a number of clips including Tom Cruise, the system can automatically provide advertisements to the user to purchase movies including Tom Cruise, such as Top Gun.

In other examples, the advertisements can be selected based on the video content that is delivered to the recipient. In one embodiment, the user can personalize the advertisement that is sent with online greeting cards by, for example, selecting which advertisements are displayed to the recipient, as well as by displaying a message to the recipient before and/or after the advertisement. The user can thereby select advertisements in which the recipient might be interested, or select advertisements that the recipient might find amusing.

In some embodiments, various advertisements can be embedded into the scene itself. For example, the user can select among various advertisements to add to the scene as the user edits the scene with the edit module 330. For example, the user can embed advertisements over billboards that are visible in the background of an old movie scene to modernize it. Other configurations are possible.

In other examples described herein, advertising can be based on an analysis of the user's storage module 280. For example, the system 100 can be programmed to automatically analyze the content of the user's storage module and deliver relevant advertising to the user in the user interface 270 based on that content. In some examples, advertisements are displayed at certain intervals as the user accesses video content on the system 100. For example, in one embodiment, a commercial is run after the individual watches a certain number of video clips on the system 100, such as 2, 5, 8, or 10 clips.

In example embodiments, the video content itself is not delivered with the message that is sent to the recipient. Instead, the message includes a link that the recipient accesses to view the content. In such an instance, the video content can be delivered in a frame or window defined in the web page delivered to the recipient's browser. In this configuration, the video content can be stored on a data store owned by another entity, such as is shown in FIG. 1. In other embodiments, the video content can be attached to the message itself.

In some embodiments, the delivery of the video content can be tailored to the client with which the recipient uses to access the greeting. For example, the video content can be delivered in a standard compressed format, such as MPEG, AVI, or WMV, if the recipient uses a desktop computer with a dial-up or high speed connection. In some embodiments, the content can be delivered in other, more compact formats if the recipient uses a mobile device such as a cellular telephone or personal data assistant to access the content. In such an instance, the video content can be delivered in a more highly-compressed state to reduce file size to expedite delivery and viewability.

For example, in one embodiment, the system 100 includes an application is run on a user's handheld device, such as a cellular device running Microsoft's Windows Mobile® software operating system or Apple's iPhone. In these examples, the user can install an application on the user's handheld device that allows the user to access the system 100 to store, view, and share video content. For example, the user can install an application on the user's handheld device that allows the user to access the user's storage module to search through and play video content stored thereon. Other configurations are possible.

In addition to being compressed, the video content can also include security to protect the video content from unauthorized reproduction. For example, the video content can include digital rights management (DRM) features that only allow the video content to be streamed and not to be stored locally on the recipient's computer. Alternatively, the DRM features can limit the duration (e.g., viewable for five days) or number of times that the video content can be viewed. For example, the user can pay a premium to allow the video content to be viewed by the recipient for a greater number of times (e.g., viewable for five times as opposed to standard two times), or can pay a premium to remove DRM restrictions so that the video content can be stored, viewed, and/or reproduced by the recipient without restrictions. Other configurations are possible.

In example embodiments, the greeting is delivered to the recipient in a form such as an email or a text message. The message includes a link that allows the recipient to access the scene, along with any customizations added by the user.

For example, in one embodiment, the greeting is delivered to the recipient by email. The email includes a slogan (e.g., “You've been Flicked!” or “Flick her back!”), as well as a graphic including a photo (e.g., a part of the selected scene, freeze-framed) tucked into an envelope. The recipient can then click on the envelope to access the scene. Examples of scenes that have been shared in this manner are shared scenes 457, 459 shown in example social network page 452, described below.

In other examples, the video content can be stored on the user's storage module or on a social network site, such as Facebook (www.facebook.com). In this manner, the user can have the greeting delivered to the recipient's social networking page. When the recipient next accesses the page, notification of the greeting is provided, and the recipient can select to view the greeting within a frame on the page. Other configurations are possible.

In example embodiments, the user can incorporate video content on the user's social network site by selecting the social networking module 276 from the user interface 270 in FIG. 3. For example, the user to incorporate various aspects of the systems and methods described above into the user's social networking page (e.g., Facebook (www.facebook.com) or Myspace (www.myspace.com)).

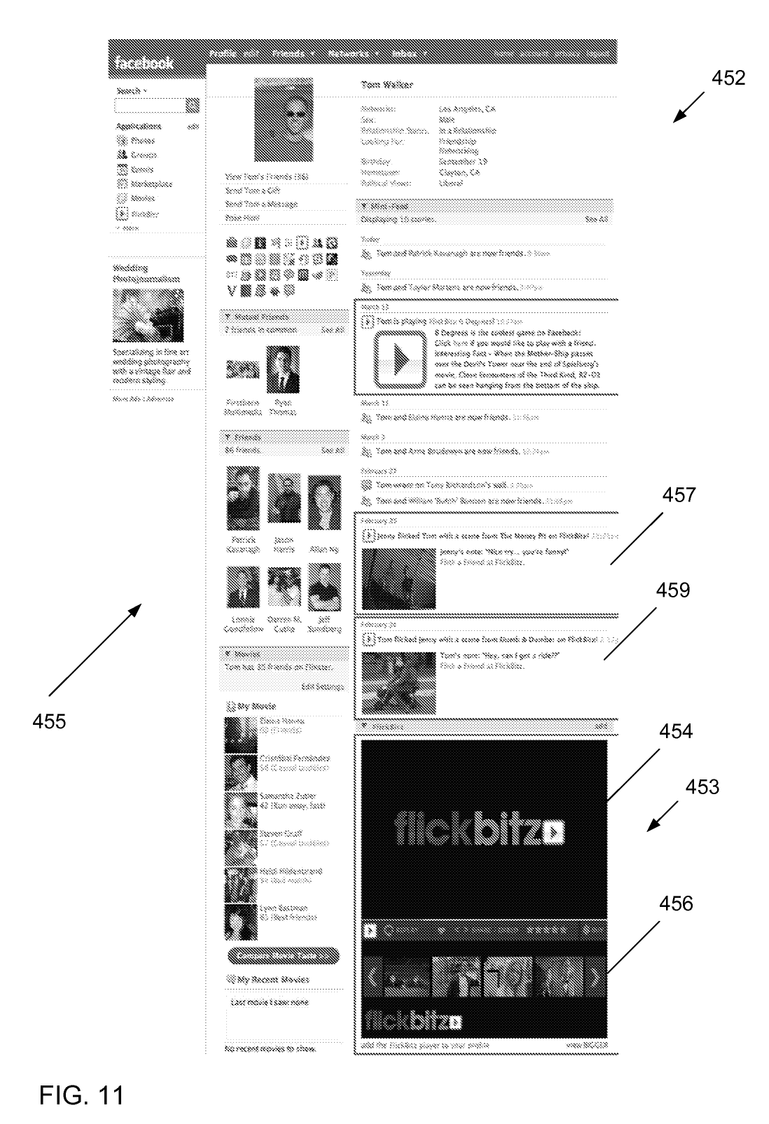

For example, referring now to FIG. 11, the example social network page 452 is shown. A widget 453 that can be used to share and play the video content is included as part of the social network site 452. In example embodiments, the widget 453 is a plug-in that is added to the user's page 452. In alternative embodiments, the widget 453 can be a stand-alone application or a web-based application.

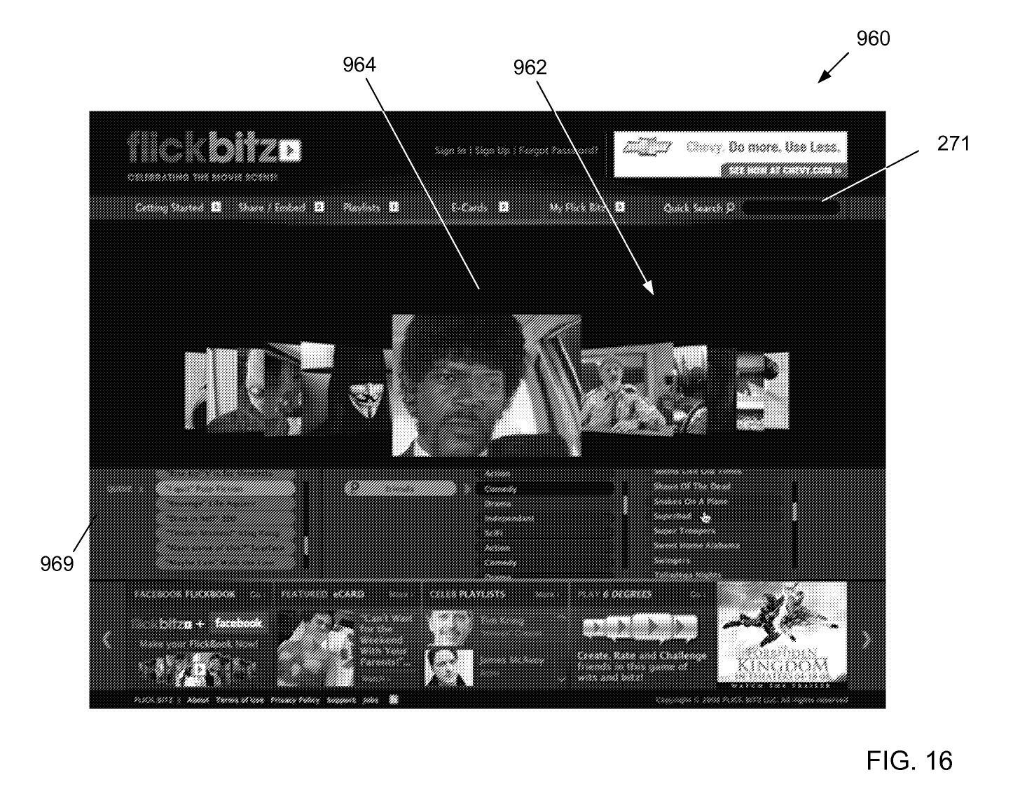

The widget 453 includes a player 454 that allows a visitor to the user's social network site 452 to play the video content creating using the system 100. In addition, the widget 453 includes an interface 456 (see, e.g., FIG. 16 described below) that allows the visitor to flip through various video content to select content to view and/or distribute.

In example embodiments, the widget 453 allows the user to access part or all of the functionality of the systems and methods described above. For example, the user can send and receive online greeting cards including video content within the widget 453 on the user's page 452. In addition, as described previously, the user can send other users (referred to as “flicking” above) video clips through the widget 453. These communications can be accomplished in various formats, such as through email, instant messaging, text or video messaging, or through proprietary messaging schemes offered by particular social networking sites.

In some examples, visitors can provide commentary and/or rate the video content in the widget 453. In one embodiment, visitors can send comments to the user on the video content and can rate it on a scale. The ratings can be used by the user, the social network site, and/or the system 100 to identify popular clips. For example, the ratings can be automatically provided to the system 100 so that the system can modify the placement of the thumbnail images 924 on the storage module 290 (see FIG. 5) to reflect the ratings of the video content. Other configurations are possible.

In addition, when a user is “flicked,” the widget 453 can also provide the user with suggestions on clips that might be sent in response to the “flick.” For example, the widget 453 is programmed to suggest responding to a flick including a clip from the “Money Pit” of Tom Hanks laughing with an indication that certain other users had responded to the clip by sending the clip from “Goodfellas” with Joe Pesci saying “You think I'm funny? Funny how? Like a clown?” The user can then, if desired, select one of the suggested clips and send it back to the original sender in reply to the original flick.

In other examples, the widget 453 is further programmed to analyze content associated with the user's social networking page 452 and to suggest clips based on the analysis. For example, the widget 453 is programmed to automatically analyze text associated with other content 455 on the user's page 952 and to suggest content-specific clips that might be of interest to the user within the widget 954. For example, if the user's page 452 includes text related to the user's interest in mountain climbing, the widget 453 is programmed to analyze that text and to suggest to the user video clips that are thematically related to that interest, such as clips from the movie “Vertical Limit.” In another example, if the widget 453 analyzes the user's page 452 and determines that the user attended Indiana University, the widget 453 can be programmed to suggest appropriate video clips such as clips from “Hoosiers.” In yet other examples, the widget 453 can be programmed to automatically analyze the content of the video clips on the user's page 452 and suggest content as well.

In yet other embodiments, the widget 453 can be programmed to analyze other user's social networking pages and to suggest to the user video clips that are consistent thematically with the other users' pages. For example, the user can have the widget 453 analyze a friend's social networking page and automatically suggest video clips consistent thematically with the friend's page. The user can then select one or more of the clips and send the clips to the friend.

In addition, the widget 453 can be programmed to assist the user to string a series of clips together to form a mashup clip associated with certain aspects of the user's life. For example, if the widget 453 analyzes the user's page 452 and determines that the user went to Indiana University, joined the Peace Corps, and enjoyed skiing, the widget 453 can suggest clips associated with each of these themes for the user's selection and creation of a mashup clip. The user can select particular scenes (or allow the widget 453 to automatically select the scenes) to create and save a mashup clip representing the user's “movie of my life.”

In other examples, the widget 453 can be programmed to monitor communication (e.g., email, instant and text messaging, etc.) and suggest video clips that are content-appropriate for the message. For example, if the user types “LOL” (i.e., shorthand for “Laughing Out Loud”), the widget 453 can automatically suggest video clips that include laughing scenes. Other configurations, such as triggers based on different emotthumbnail images, can also be used. Such functionality can be similar to a video version of emotthumbnail images.

In example embodiments, the video content that is reviewed and tagged for the system 100 can include both public domain and copyrighted works. For example, the video content can include video that is available from popular video share sites such as YouTube (www.youtube.com). In addition, a licensing arrangement between the system 100 and video content owners, such as movie studios, can be arranged to make copyrighted works available on the system 100. A revenue-sharing approach can include a royalty that is paid to the copyright owner for each scene that is purchased by a user of the system 100. For example, the system 100 can be viewed as a distributor of film scenes, and therefore can share revenues with the copyright owners (e.g., a 50/50 split) similar to other exhibitor agreements. This allows copyright owners to develop a new source of revenue that is generated from pre-existing (i.e., non-original) content. As described above, the copyright owner can continue to maintain control over the video content itself.

In some examples, advertisements are shared with actors, writers and other talent. An advertiser can target a particular actor's channel (see above), and therefore that actor can share in the revenue generated from the adds. Other configurations are possible.

Users can create accounts on the server 120 to include profile information and to access previously-sent greetings. In addition, users can pay a premium for a monthly or yearly membership that reduces or eliminates the costs associated with using video content and reducing advertisements. For example, a user can purchase a membership for unlimited use of video content and no advertisements being shown to recipients. In other examples, the content is free.

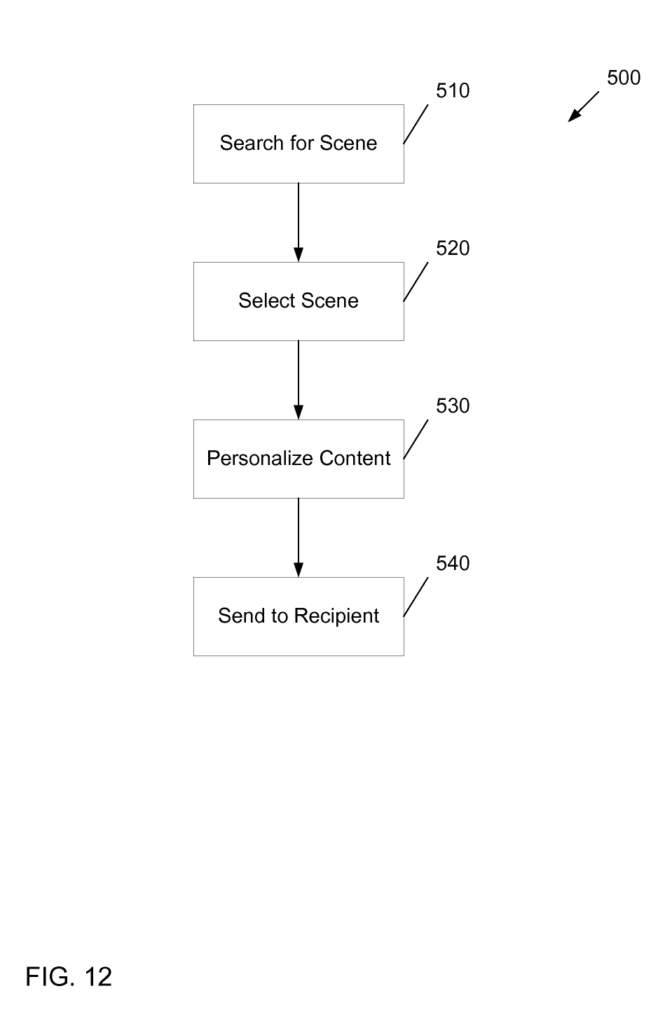

Referring now to FIG. 12, an example method 500 for a user to create a greeting is shown. Beginning at operation 510, the user searches for content such as a desired scene. For example, the user can browse or perform keyword searches for a scene. Next, at operation 520, the user selects the desired scene for the greeting.

At operation 530, the user customizes the scene by editing and personalizing the scene. This can include, for example, changing the attributes related to the scene (e.g., length etc.), as well as add other content like text boxes, commentary, and graphic interfaces. Finally, at operation 540, the user finalizes the greeting and sends the greeting to the recipient.

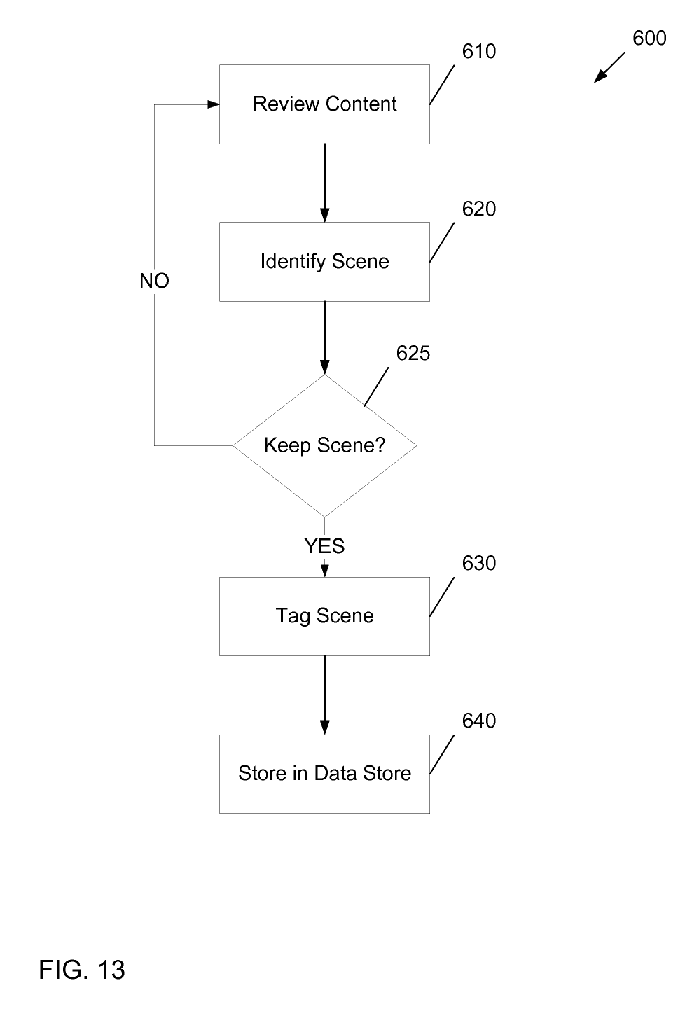

Referring now to FIG. 13, an example method 600 for reviewing video content for inclusion in the system is shown. Initially, at operation 610, content such as a movie, television program, or sports event is reviewed. Next, at operation 620, a scene is identified from the content. Next, at operation 625, a decision is made as to whether or not to include the scene in the system. If the decision is negative, control is passed back to operation 610.

Alternatively, if the decision at operation 625 is positive, control is passed to operation 630, and the scene is tagged using one or more of the automated or manual processes described above. In some examples, tags can be added by the studio that creates the content, and additional tags can be added using the processes described herein, if desired. Finally, at operation 640, the scene is stored in the data store and made available for users to choose as part of a greeting.

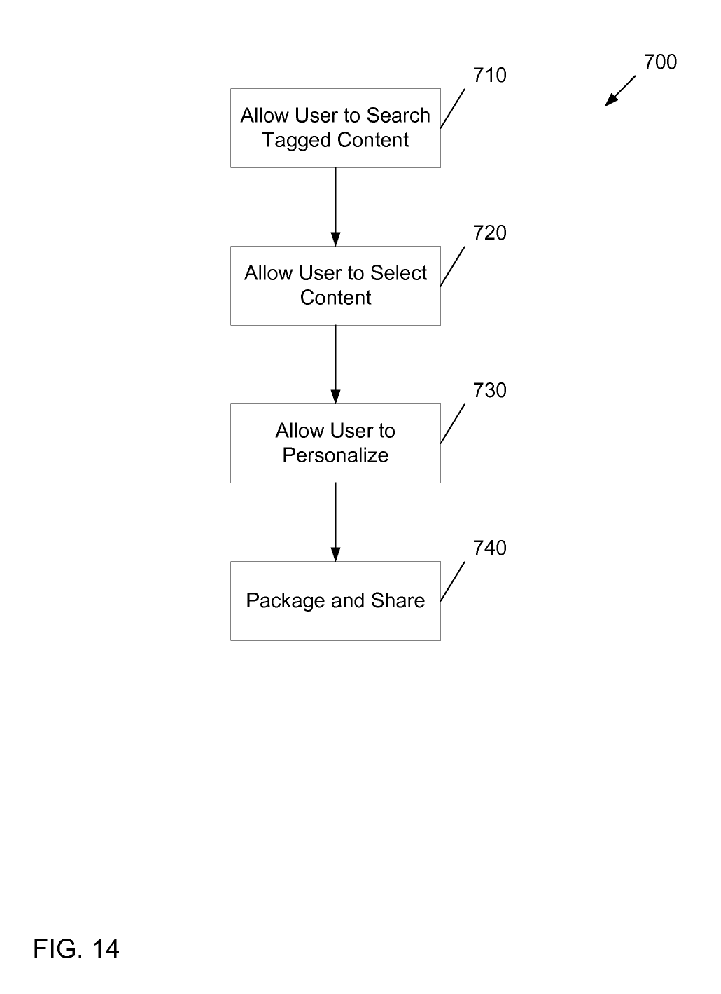

Referring now to FIG. 14, an example method 700 is shown for allowing a user to find and manipulate video content. At operation 710, the user is allowed to search tagged scenes to identify a desired scene. Next, at operation 720, the user is allowed to select one or more scenes. At operation 730, the user is allowed to customize the video scenes by editing and personalizing the scenes. Finally, at operation 740, the video content is packaged and shared as desired.

Although the examples described herein relate to the use of non-original video content, in some embodiments the users can upload original video content created by the user. In such an example, the user can customize the video content (e.g., edit and personalize) and greeting sent to the recipient as described above.

Referring again to FIG. 3, when the user selects the game module 274, the game module 274 is programmed to present one or more games associated with the video content available on the system. One possible game relates to the selection of similarly-situated scenes to create a string of scenes that have a specific effect or otherwise create a desired theme.

For example, in one embodiment, the user can play interactive, online games that allow multiple users to work with each other in connecting similarly-themed movie clips together. In such a game, movie clips are categorized online by users watching the clips, tagging the clips based on content, and/or assigning the clips to certain folders or population clusters (i.e., repositories of clips having similar thematic qualities). In example embodiments, the clips can be tagged thematically (e.g., by viewing and placing tags into a tag cloud associated with the clip) or based on various other attributes such as actor, producer, etc., as described above.

This can be accomplished, for example, by tagging a clip with text and/or by dragging and dropping a clip digitally into a population cluster. Populations of movie scenes can be titled, for example, “Car Chases,” “Church Confessionals,” “Phone Booths,” “Apologies,” “Pouring Wine,” etc. There can be tens of thousands of movie clip populations that are shared among users. Each population can hold a varying number of clips. For example, “Boy Kisses Girl” may have 4,000 clips, whereas “Church Confessionals” may have only 42 clips. Further, a single movie clip from the film “Grease” may find a home in multiple populations, such as “Fifties,” “John Travolta,” “Actresses who have survived breast cancer (Olivia Newton John),” “Chevy Chevelle,” “Greasy Hair,” or “Saddle Shoes.”

Online users can then connect populations together by finding a single clip that shares characteristics from both populations, such as “a boy kisses a girl in a church confessional,” and therefore those two populations are linked. With those populations connected, users may move on to other populations to attempt to connect them, or to create more categories that may allow the possibility of new connections in different ways.

The game itself can include multiple levels, such as connectibility between scenes based on real life statistics of actors, or connectibility based on themes of scenes, and so on. Users can challenge each other to help build certain pathways through various scenes. For example, a user can choose a beginning scene and an ending scene, like a “Pulp Fiction” scene and a scene from “When Harry Met Sally,” and challenge friends to connect those two scenes thematically in a certain number of scenes or less. Or, in exactly a certain number of scenes. Or, to drop other scenes in that must be intersected along the way.

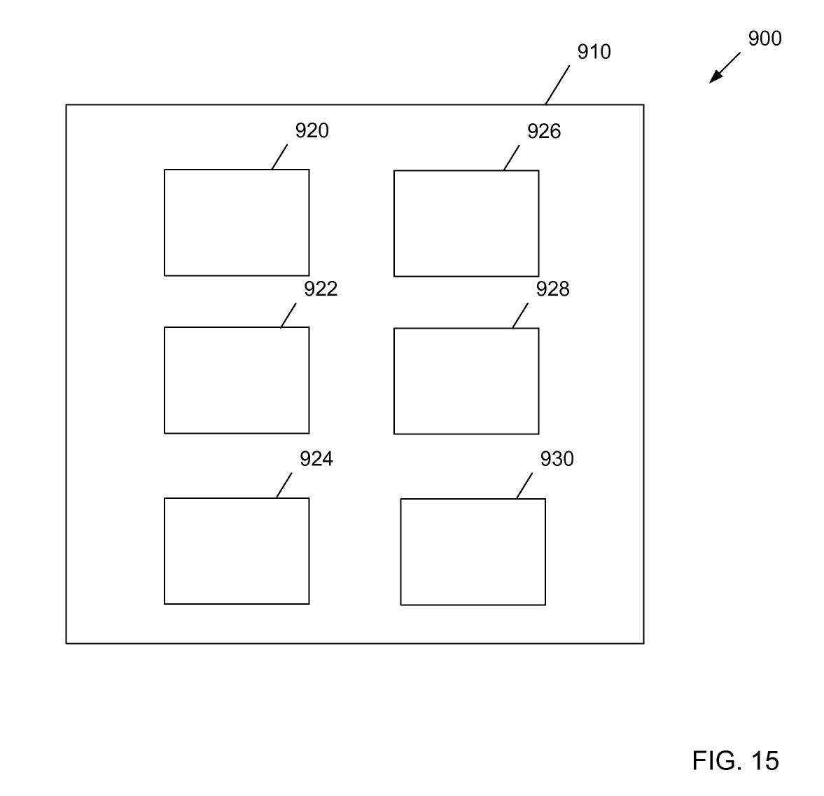

Referring now to FIG. 15, a similar game 900 is shown. In the game 900, an interface 910 is presented to the user in the user's internet browser. The interface 910 includes a plurality of thumbnail images 920, 922, 924, 926, 928, 930, with each icon including a thumbnail or otherwise representing a video clip. Each video clip is from a different production, such as a different movie or television show. The user can select each of the thumbnail images 920, 922, 924, 926, 928, 930 to view the respective clips. The user is then tasked with placing the video clips in order to create a coherent scene when the individual clips are viewed together.

In some examples, there is a correct answer, in that the clips are pre-selected so that the clips can be pieced together to create a coherent video scene. In other examples, the clips are randomly selected, and the user is simply tasked with creating a series of clips that include two or more of the clips to form a scene.

In another similar game, the user can select a series of themes based on the tags associated with the video clips. For example, the user can select themes such as “boy meets girl,” “boy kisses girl,” “girl slaps boy, and “boy and girl break up.” The themes can be placed in a coherent order such as that listed previously, and the user can then request that the system randomly pull clips with tags corresponding to each of the noted themes and place the scenes in the noted order. The user can then view and share the resulting scene including each of the clips. Other variations are possible.

In other examples, a game allows the user to create combination of clips and have other users try to guess how the themes of the clips are connected (similar to a rebus puzzle). In one variation, the user challenges others to connect or disconnect clips, or to swap new clips for clips already included in the combination scene. In yet other embodiments, the user can create combinations that connect spoken words, where a string of short clips are used to form a complete sentence. Other variations are possible.

In yet another example, the user can play a game based on the correlation of the user's movements with actions in a video clip. For example, the user can use input devices associated with a game console, such as the Nintendo® Wii, to track the user's movements. Examples of such input devices include controllers and suits that can be placed on the user's body to estimate the position of various parts of the user's body, such as the position of the user's head, arms, torso, legs, and/or feet. These input devices allow the user to mimic action that happens in a video clip, such as the movements of an actor in the video clip. The game can involve rating or estimating how closely the user can track the action in the video by using motion recognition to identify the movements of the relevant entity (e.g., actor) in the video clip. In other examples, the movement of the relevant entities can be pre-programmed or can be captured at the time the scene is filmed using, for example, sensors worn by the actor. In addition to movement, the user can mimic audio associated with the video clips as well, similar to that of a Karaoke machine.

In example embodiments, multiple users can play the game and be rated on how close each one's movements mimic the actor's movements in the video scene. The user's scores can be used to determine which one wins the game. In other examples, the user's movements can be approximated by superimposing an image for the user over the image in the video scene to show how close the user's movements approximate the actor's movements. In other examples, the video clips can be of sports events, and the user can attempt to mimic a player in the event. For example, the user can attempt to mimic the golf swing of Tiger Woods in a clip from a major golf event, or the user can attempt to mimic a homerun swing by Ken Griffey Jr. in a clip from a baseball game.

In yet other examples, the user can mimic a particular action, and the game console can be programmed to search for video clips on the system 100 that approximate that action and play the clips for the user. For example, if the user mimics swinging of a baseball bat, the game console can identify that action, query the system 100, and identify video clips of video clips, such as the homerun scene from “Field of Dreams.” These video clips can be automatically downloaded and played in succession by the game console. Other configurations are possible.

In some examples, prizes can be given to users that finish a game successfully. Examples of such prizes include access to additional or proprietary content on the system. For example, one prize could include a free online greeting including video content that can be sent to a recipient.

In any of the previous examples, the user can save the resulting scene including the various video clips and share the scene with others. In some examples, the users can select a plurality of individual clips to develop an entire scene or multiple scenes based on clips from different theatrical productions. For example, in one embodiment, the user can select clips and place the clips in order on a user interface. The user can manipulate each clip as desired and then save the clips as a single file. The resulting scene or scenes then become a clip similar to a video mashup clip. Other variations are possible.

Referring now to FIG. 16, in some embodiments, an interface 960 is provided that allows the user to flip through various scenes to select scenes to view and/or distribute. In the example interface 960 shown, a plurality of video clips 962 are illustrated using thumbnail images. The thumbnail images can be presented in a rolodex-type fashion to allow the user to quickly flip through the video clips. The user can select the video clip 964 that is in focus to play the clip. In addition, the user can search for other clips by entering keywords (e.g., title, actor, producer, tag, etc.) into the search box 271 to populate additional or different video clips into the interface 960.

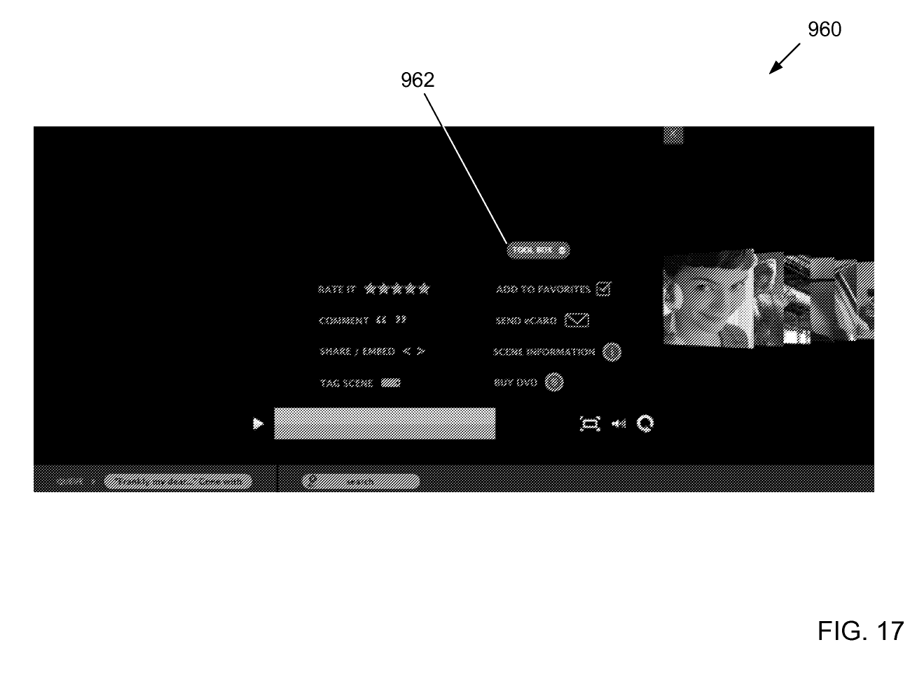

Referring now to FIG. 17, during playback of a clip within the interface 960, the user can also access other functionality by selecting a tool box 962 button to: rate the clip (e.g., 1-5 stars); comment on the clip; tag the clip; add the clip to the user's list of favorite clips; send the clip as an online greeting card; access further scene information associated with the clip (e.g., actor and producer names, title, etc.); or buy a DVD of the entire theatrical production from which the clip is taken. Other functionality can also be provided, such as the ability to purchase movie tickets to watch the production associated with the clip in a theater, to rent the DVD associated with the clip, or to download and/or purchase the clip or the production associated with the clip.

In some examples, the system 100 can be programmed to work in conjunction with or be incorporated into a television. For example, the system 100 can be incorporated into a set-top box, such as a standalone console or as part of a digital video record, DVD player, cable box, or the like. In other embodiments, the system 100 can be programmed directly into the television using, for example, one or more chips that are embedded into the television.

The system 100 can be programmed to interface with the server 120 over the Internet using wired or wireless communications. In this configuration, the system 100 can provide video content that can be played on the television. For example, the system 100 can provide the user interface 270 and allow the user to access and play video content from the user's storage module. In other examples, the system 100 can be programmed to capture content that is played on the television and store that content on user's storage module on the system 100. In other examples, the system 100 is programmed to automatically track the type of shows that are watched by the user on the television and automatically suggest video content based on that tracking. For example, the system 100 can determine that the user watches movies with Paul Newman and thereupon suggest other video content associated with him. Also, video content such as movies and television shows can be rented and viewed on the television using the system 100. Other configurations are possible.

The various embodiments described above are provided by way of illustration only and should not be construed to limiting. Those skilled in the art will readily recognize various modifications and changes that may be made to the embodiments described above without departing from the true spirit and scope of the disclosure.

What is claimed is:

1. A computer device programmed for managing online video content, the computing device comprising:
a processing unit that is capable of executing instructions; and
a non-volatile computer-readable storage device that stores:
a search module programmed to allow a user to search for video content, the video content including video clips from movies; and
a storage module programmed to operate as a central hub for management of the user's video content, the storage module allowing the user to add, delete, view, categorize, send, receive, edit, and comment on video clips that are stored on the user's storage module, the storage module being programmed to provide a page on which representations of the video clips are shown and organized, and the storage module being programmed to allow the user to interact with storage modules of other users for purposes of assessing compatibility, dialogue, comments, greetings, gifts, and recommendations.

2. The computer device of claim 1, wherein the storage device is further programmed to allow the user to organize the user's video clips that are stored on the storage device based on different criteria and to share the video clips on the storage module with other users.

3. The computer device of claim 1, wherein the storage device is further programmed to compare the user's video content stored on the storage device with another user's storage device to identify similarities or differences.

4. The computer device of claim 1, wherein the storage device is further programmed to allow the user to organize the video clips based on a plurality of different criteria.

5. The computer device of claim 1, wherein the storage module is further programmed to display thumbnail images that represent each of the video clips such that:
the storage module allows the user to select one of the thumbnail images to play a video clip associated with the one thumbnail image;
the storage module arrangements the thumbnails in an array; and
the storage module dynamically re-arranges the thumbnails based on criteria selected by the user.

6. The computer device of claim 5, wherein the storage module is further programmed to increase a size of certain ones of the thumbnail images to indicate increased prominence for those images.

7. The computer device of claim 1, further comprising a widget module that is programmed to plug into a social networking site to allow the user's video clips from the storage module to be played on the social networking site.

8. The computer device of claim 1, wherein the search module is further programmed to allow the user to search for video content by classifications or keywords.

9. The computer device of claim 1, further comprising a tag module that is programmed to break the video content into scenes, and to assign one or more tags to each of the scenes for later retrieval by the user.

10. The computer device of claim 9, wherein the search module is further programmed to allow the user to search for video content by the tags.

11. The computer device of claim 1, further comprising:
an edit module programmed to allow the user to edit a run time for a selected video clip;
a personalize module programmed to allow the user to add text to be associated with the video clip; and
a package module programmed to store the video clip and to allow the user to share the video clip with another user; and

12. The computer device of claim 11, wherein the edit module is further programmed to allow the user to trim segments from the user's selected video clip and to combine the segments.

13. The computer device of claim 11, wherein the personalize module is further programmed to interpose the text onto the selected video clip.

14. The computer device of claim 11, wherein the package module is further programmed to incorporate the selected video clip into an online greeting card that is sent to the other user.

15. The computer device of claim 11, further comprising a game module programmed to associate the video clip with a game played by the user.

16. The computer device of claim 11, wherein the selected video clip is a scene from a full-length movie.
